(19) United States
(12) Patent Application Publication
(10) Pub. No.: US 2018/0033036 A1
(43) Pub. Date: Feb. 1, 2018

(54) SINGLE AND MULTI-TENANT RULE DRIVEN CREDITING SYSTEMS AND METHODS

(71) Applicant: NCR Corporation, Duluth, GA (US)

(72) Inventors: Sean Paul Loosli, Mountain View, CA (US); Brad Ennis, Duluth, GA (US); Ram Ridgeway, Beavercreek, OH (US)

(21) Appl. No.: 15/223,733

(22) Filed: Jul. 29, 2016

(51) Int. Cl. G06Q 30/02; G06Q 20/24; G06Q 20/34; H04L 29/08; G06Q 20/10

(52) U.S. Cl. CPC G06Q 30/0226; H04L 67/306; G06Q 20/10; G06Q 20/34; G06Q 20/24

(57) ABSTRACT

The various embodiments herein each include at least one of systems, methods, and software for single and multi-tenant rule driven crediting systems and methods, such as may be utilized for implementing reward programs that reward customer loyalty. One such embodiment in the form of a method includes receiving input defining a rule to be applied against transaction data, the rule identifying at least one applicable transaction type and a value to be credited to an account associated with an account involved in the transaction. The method further includes storing the rule in a rulebase of a plurality of rules. The method also may include executing a rules engine to apply rules of the rulebase against transactions in a transaction system where a type of a respective transaction matches the at least one applicable transaction type of a respective rule.

### BACKGROUND INFORMATION

Entities often provide commodity products or products that have very little differentiation over the products of their customers. To establish differentiation over their customers, entities have implemented reward programs. However, implementation of differentiated reward programs has been limited by fixed reward solution computing systems.

### SUMMARY

The various embodiments herein each include at least one of systems, methods, and software for single and multi-tenant rule driven crediting systems and methods, such as may be utilized for implementing reward programs that reward customer loyalty. One such embodiment in the form of a method includes receiving input defining a rule to be applied against transaction data, the rule identifying at least one applicable transaction type and a value to be credited to an account associated with an account involved in the transaction. The method further includes storing the rule in a rulebase of a plurality of rules. The method also may include executing a rules engine to apply rules of the rulebase against transactions in a transaction system where a type of a respective transaction matches the at least one applicable transaction type of a respective rule.

### BRIEF DESCRIPTION OF THE DRAWINGS

FIG. 1 is a logical block diagram of a system, according to an example embodiment.

FIG. 2 is a block diagram of a computing device, according to an example embodiment.

FIG. 3 is a logical block diagram of a method, according to an example embodiment.

### DETAILED DESCRIPTION

There are currently numerous reward programs on the market. Most reward programs are based on purchase activity rather than interactions with the business. Others are a standard platform where the business can select from a limited sub-segment of rewards based on the vendor's virtual store. Still others reward health activity by meeting certain thresholds. The solutions herein are highly customizable and can be mapped directly to business value, the transaction types and the interactions that an entity desires to encourage as they provide the greatest value either in direct bottom line enhancement or deepen relationships with customers such that there is an indirect positive enhancement to the business.

Some embodiments include a configurable platform that allow an entity, such as a business, to create a portfolio of desired behaviors, also referred to as transaction types, the occurrence of which may be configured to trigger a variety of possible rewards. These behaviors could include purchases and registration for services, but also activities that would indicate ongoing engagement, such as website logins, continued direct deposit, mobile app usage, establishing a brokerage account, purchasing an equity within a brokerage account, meeting a spending threshold on a credit or debit card, enrolling in or receiving online statements, bill pay utilization, opening additional accounts, maintaining a minimum balance, among other possible activities that may be captured in data.

Some embodiments may also include mechanisms by which user visits to stores or branches and areas therein are automatically identified and rewards may be provided for such behaviors. Such embodiments may utilize beacon devices, such as BLUETOOTH® beacons that are deployed to the locations where a visit provides a reward. Data from a beacon device may be received by an app on a customer mobile device and the app may log a visit to a location of that beacon device for a user logged into the app. In other embodiments, Global Positioning System (GPS) data may be utilized as well as other location-determining solutions that operate based on one or more received WI-FI signals, wireless service towers connected to, and the like.

The business implementing the particular solution is able to target behaviors that they would like to encourage, and assess the expected value of the behavior, and then set the reward accordingly. Some such solutions include an administrator solution and a corresponding consumer facing solution. The consumer side may be a rewards widget within an online consumer website, mobile app, or software application that presents information relevant to the user's account. This may include points or other value (e.g., airline miles, virtual currency, cash value, etc.) accrued, current status, ability to claim rewards, and suggestions of how more rewards could be earned. In some embodiments, the rewards may be or include badges or other graphical elements that are presented to a user, can be shred on social media, and the like. The administer solution of some embodiments includes a portal with options to define and customize the activities desired to be rewarded and set a corresponding reward value.

Some such embodiments may be deployed in an integrated manner with other systems that log business/customer interactions, such as transaction systems which may include banking systems, payment card (e.g., charge, credit, and debit card systems), telephone and wireless service usage tracking systems, and the like. Such embodiments may execute against data stored in or by such systems in real time or at later times, be integrated within objects of such systems to record point accruals in real time, and otherwise. Such embodiments, although different, generally automatically update the reward point values. However, administrators or other employees may manually enter point values into the system, such as by allowing entry of data for offline activities that may not be captured or otherwise known to data processing systems thereby still allowing for reward accruals.

These and other embodiments are described herein with further reference to the figures.

In the following detailed description, reference; made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

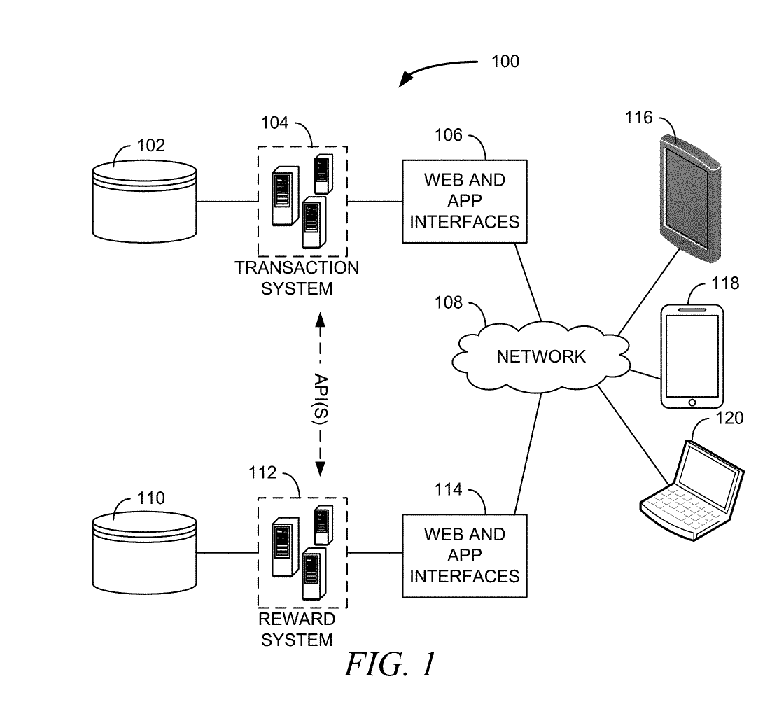

FIG. 1 is a logical block diagram of a system 100, according to an example embodiment. The system 100 is an example of a system and system components of some embodiments herein. The system 100 illustration of FIG. 1 is presented in simplified form to assist in more easily conveying and ease of understanding. As illustrated, the system 100 includes a transaction system 104 and a reward system 112.

Transactions are conducted in a data processing sense on the transaction system 104. Of course there are other components involved in the transaction system 104, such as there may be cash registers within stores, billing systems for subscription services, ecommerce systems for processing orders and payment received online via web and app interfaces 106, teller systems and automated teller machines at banks, and the like, depending on the business of the entity operating the transaction system. The transaction system 104 is typically connected to one or more databases 102 and services and data of the transaction system 104 may be accessible for client and customer interaction via interfaces, such as web and app interfaces 106. The web and app interfaces 106 connect to a network 108, such as the Internet, to enable client devices and software thereon, such as thin and thick client applications, web browsers, and mobile device apps to interact with the transaction system 104.

The network 108 also enables the client devices to connect to the reward system 112 via web and app services 114 thereof, which may include accessing data stored in one or more databases 110 of the reward system 112. The reward system 112 generally includes customized and customizable rules that are applicable to transaction types within the transaction system 104 to grant rewards, such as points, miles, or other value to a reward account of a customer involved in a transaction. The reward system 112 generally includes an administrator interface, accessible via the web and app interfaces 114 or otherwise to create, update, and delete rules the application of which will provide rewards. The reward system 112 also generally includes customer interfaces that allow customers to view reward balances, suggestions on how to accrue more rewards, and to redeem rewards.

In some embodiments customers may access customer online and app services of both the transaction system 104 and the reward system 112 via a single website or single mobile device app.

In some embodiments, application programming interfaces (APIs) of one or both of the transaction system 104 and reward system 112 expose data processing interfaces, services, methods, processes, and data of one to the other and vice versa. Thus, in some embodiments, rules generated and stored by the reward system 112 are applied by a rules engine against transaction data of the transaction system 104 via those interfaces. The rules engine may be present on the reward system, integrated within or added on as a module of the transaction system, integrated within objects of the transaction processing system 104, and the like.

In some embodiments, there may be a plurality of transaction systems 104 and only a single reward system 112. The reward system 112 is such embodiments may thereby be a multi-tenant system deployed in a manner that has become commonly known as a cloud-based solution or “in the cloud”.

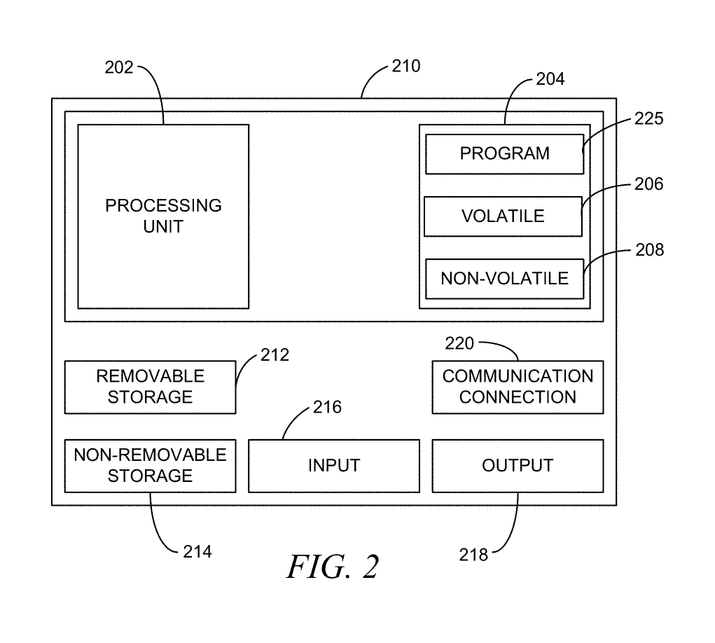

FIG. 2 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. The computing device illustrated in FIG. 2 is a general example of a computing device that may be deployed as a computer on which one of the databases 102, 110, the transaction system 104, the reward system, mobile devices 116, 118, personal computer 120, and other devices of the system 100 of FIG. 1 may be deployed.

One example computing device in the form of a computer 210, may include a processing unit 202, memory 204, removable storage 212, and non-removable storage 214. Although the example computing device is illustrated and described as computer 210, the computing device may be in different forms in different embodiments. For example, the computing device may instead be a smartphone, a tablet, smartwatch, or other computing device including the same or similar elements as illustrated and described with regard to FIG. 2. Devices such as smartphones, tablets, and smartwatches are generally collectively referred to as mobile devices. The devices may also include other device types or device “things” that connect to the Internet or other network to provide or participate in providing implementations of the various embodiments herein. Further, although the various data storage elements are illustrated as part of the computer 210, the storage may also or alternatively include cloud-based storage accessible via a network, such as the Internet.

Returning to the computer 210, memory 204 may include volatile memory 206 and non-volatile memory 208. Computer 210 may include—or have access to a computing environment that includes a variety of computer-readable media, such as volatile memory 206 and non-volatile memory 208, removable storage 212 and non-removable storage 214. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 210 may include or have access to a computing environment that includes input 216, output 218, and a communication connection 220. The input 216 may include one or more of a touchscreen, touchpad, mouse, keyboard, camera, one or more device-specific buttons, one or more sensors integrated within or coupled via wired or wireless data connections to the computer 210, and other input devices. The computer 210 may operate in a networked environment using a communication connection 220 to connect to one or more remote computers, such as database servers, web servers, and other computing device. An example remote computer may include a personal computer (PC), server, router, network PC, a peer device or other common network node, or the like. The communication connection 220 may be a network interface device such as one or both of an Ethernet card and a wireless card or circuit that may be connected to a network. The network may include one or more of a Local Area Network (LAN), a Wide Area. Network (WAN), the Internet, and other networks. In some embodiments, the communication connection 220 may also or alternatively include a transceiver device, such as a BLUETOOTH® device that enables the computer 210 to wirelessly receive, data from and transmit data to other BLUETOOTH® devices.

Computer-readable instructions stored on a computer-readable medium are executable by the processing unit 202 of the computer 210. A hard drive (magnetic disk or solid state), CD-ROM, and RAM are some examples of articles including a non--transitory computer-readable medium. For example, various computer programs 225 or apps, such as one or more applications and modules implementing one or more of the methods illustrated and described herein or an app or application that executes on a mobile device or is accessible via a web browser, may be stored on a non-transitory computer-readable medium.

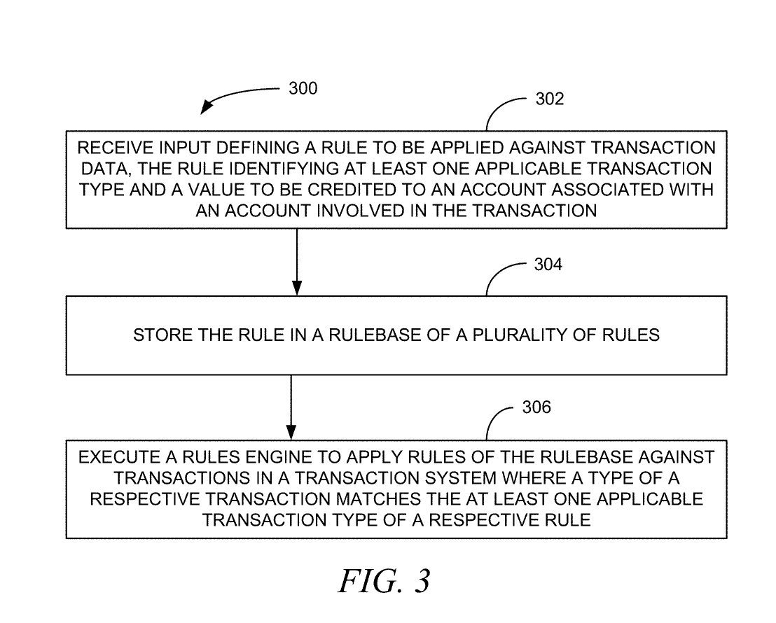

FIG. 3 is a logical block diagram of a method 300, according to an example embodiment. The method 300 is an example of a method that may be performed in whole or in part on one or both of the transaction system 104 and the reward system 112 of FIG. 1. The method 100 may be performed to define, customer, deploy, and apply configurable rules against transaction data, such as to grant rewards.

The method 300 includes receiving 302 input defining a rule to be applied against transaction data. The rule of some such embodiments typically identifies at least one applicable transaction type and a value to be credited to an account associated with an account involved in the transaction. The method 300 further includes storing 304 the rule in a rulebase of a plurality of rules and subsequently executing 306 a rules engine to apply rules of the rulebase against transactions in a transaction system. A rule may be applied when executing 306 the rules engine where a type of a respective transaction matches the at east one applicable transaction type of a respective rule.

In some embodiments of the method 300, accounts to be credited according to a rule stored in the rulebase are accounts designated within customer profiles to which reward credits are to be credited.

In some embodiments, the rules engine executes 306 at least in part as a process of or as a module added onto to banking computing system. In some such embodiments, accounts to which value is to be credited are accounts to which value is credited by rules of a plurality of rulebases of respective different entities, such as in a cloud-based, multi-tenant embodiment of a rewards system.

In another embodiment, the value to be credited portion of a rule is a reference to a configuration setting stored and configurable separately from the rule. Such embodiments provide a flexibility and openness in use, maintenance, and configurability of such solutions.

in another embodiment, receiving 302 the input defining the rule applied against transaction data further includes receiving input identifying at least one account type to which the rule is applicable. In some such embodiments, the rules engine executes 306 at least in part against transaction data of a banking computing system to identify transactions of accounts of account and transaction types of rules stored 304 in the rulebase and to apply the applicable rules against those transactions conducted with accounts of the relevant types. In another similar embodiment of the method 300, the at least one account type is a specific credit card account type and the at least one applicable transaction type is a purchase or payment transaction with regard to the specific credit card account type.

In some embodiments, a value to be credited is a formula within a rule that is applied against an amount of the transaction. Such as a 10 points to one dollar spent in a transaction. That formula may also take into account other factors, such as an affinity level within the reward program that provides an account holder a higher reward level (e.g., gold level member received a 50% bonus).

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving input defining a rule to be applied against transaction data;
storing the rule in a rulebase of a plurality of rules; and
executing a rules engine to apply rules of the rulebase against transactions in a transaction system where a type of a respective transaction matches at least one applicable transaction type of a respective rule.

2. The method of claim 1, wherein accounts to he credited according to a rule stored in the rulebase are accounts designated within customer profiles to which reward credits are to be credited.

3. The method of claim 1, wherein the rules engine executes at least in part as a process of or as a module added onto to banking computing system.

4. The method of claim 3, wherein accounts to which value is to be credited are accounts to which value is credited by rules of a plurality of rulebases of respective different entities.

5. The method of claim 1, wherein:
the rule identifies at least one applicable transaction type and a value to be credited to an account associated with an account involved in the transaction; and
the value to be credited portion of a rule is a reference to a configuration setting stored and configurable separately from the rule.

6. The method of claim 1, wherein receiving the input defining the rule applied against transaction data further includes receiving input identifying at least one account type to which the rule is applicable.

7. The method of claim 6, wherein the rules engine executes at least in part against transaction data of a banking computing system to identify transactions of accounts of account and transaction types of rules stored in the rulebase and to apply the applicable rules against those transactions conducted with accounts of the relevant types.

8. The method of claim 6, wherein:
the at least one account type is a specific credit card account type; and
the at least one applicable transaction type is a purchase or payment transaction.

9. The method of claim 8, wherein the value to be credited is a formula applied against an amount of the transaction.

10. A method comprising:
applying rules of a configurable rulebases against transactions of at least one transaction processing system, the number of configurable rulebases equal to the number of the at least one transaction processing systems, each rulebase applied against one of the at least one transaction processing systems.

11. The method of claim 10, wherein rules of each rulebase apply value credits to the same value credit system.

12. The method of claim 11, wherein the value credit system is a reward system that is credited by rules applied against transactions of a plurality of entities and the applied rules are rules of rulebases of the plurality of entities.

13. The method of claim 12, where a rule includes data associating the rule with a rulebase, data identifying at least one transaction type for which the rule is applicable, and a value to be credited.

14. The method of claim 13, wherein the rule further includes at least one of an applicable data or date range for the rule, an expiration data for the rule and a frequency at which the rule is to be applied.

15. The method of claim 10, wherein the rules of a rule base are applied by a process that executes against data of a transaction processing system retrieved over a network.

16. The method of claim 10, wherein the rules are applied at least in part by a process that executes within a computing environment of a transaction processing system that retrieves the rules over a network from the rulebase.

17. A system comprising:
at least one network interface device;
at least one computer processor; and
at least one memory device storing instructions executable by the at least computer processor to perform data processing activities, the data processing activities comprising:
receiving, via the at least one network interface device, input defining a rule to be applied against transaction data, the rule identifying at least one applicable transaction type and a value to be credited to an account associated with an account involved in the transaction;
storing the rule in a rulebase of a plurality of rules; and
providing rules to a rules engine when requested via the at least one network interface device thereby, the rules engine to apply rules of the rulebase against transactions in a transaction system where a type of a respective transaction matches the at leas ne applicable transaction type of a respective rule.

18. The system of claim 17, wherein:
the rules engine executes at least in part as a process of or as a module added onto to banking computing system; and
accounts to which value is to be credited are accounts to which value is credited by rules of a plurality of rulebases of respective different entities.

19. The system of claim 17, wherein the value to be credited portion of a rule is a reference to a configuration setting stored and configurable separately from the rule.

20. The system of claim 17, wherein receiving the input defining the rule applied against transaction data further includes receiving input identifying at least one account type to which the rule is applicable.
